(19) United States
(12) Patent Application Publication
(10) Pub. No.: US 2009/0224102 A1
(43) Pub. Date: Sep. 10, 2009

(54) Aircraft Wing and Fuselage Structure

(76) Inventor: Walter W. White, Rio Linda, CA (US)

Correspondence Address: JAMES R. CYPHER, 405 14TH STREET, SUITE 1607, OAKLAND, CA, 94612, US

(21) Appl. No.: 12/043,607

(22) Filed: Mar. 6, 2008

(51) Int. Cl. B64C 1/00; E04B 1/32; B64C 3/00

(52) U.S. Cl. 244/119; 52/80.1; 244/123.1

(57) ABSTRACT

A structure protected from premature buckling for resisting multiple bending forces resulting from design loads in which the resulting structural configuration is determined by the force components produced by the design bending stresses. The structure is a compound curved, relatively thin sheet of metal or a composite having a longitudinally cambered shape that is initially arched opposite to the bend that occurs when the structure is loaded and is likewise curved laterally through a substantial portion of its length. The structure is particularly suited for the construction of fixed wing airplanes and airplane fuselages using the same principles of construction. The wing structure is characterized by a concave undersurface like that of a bird's wing which results in a greatly reduced stall speed which cannot stall out at slow speeds.

### BACKGROUND OF THE INVENTION

The present invention relates to a structure which can be used as aircraft wings as well as multiple joined structures forming the fuselage. As a wing, the structure curves in a longitudinal hyper camber or excessive camber curve and also curves laterally leading edge to trailing edge forming a compound curve. In the fuselage, the multiple structures curve from nose to tail in a longitudinal hyper camber curve and also curve laterally forming a compound curve.

The present invention relates to a hyper camber aircraft structure which astoundingly can be used as the entire structural member of an aircraft wing as well as the main structural members of the fuselage. The history of winged aircraft dates back to the late 19^{th} century with glider craft such as the well known Lilienthal flying machine which received U.S. Pat. No. 544,816 on Aug. 20, 1895. As Lilienthal stated in his patent: “This invention relates to flying-machines which resemble in their construction the structure of birds' wings.” Lilienthal had no fuselage or landing gear other than a brave pilot with strong legs. The main characteristic of the Lilienthal flying wing was that it had a shape in which the underside of the wing was concave unlike the wings of airplanes today which are convex on their upper surface and relatively flat on their under surface. Substantial lift of the Lilienthal wing was due to pressure pushing upwardly on the concave under surface of the wing unlike the under surface of today's aircraft wing which is relatively flat and develops lift during horizontal flight primarily by means of the convex upper surface which creates a reduced pressure above the wing to create lift. Lilienthal's upper wing surface was convex like a bird's wing and also derived some lift due to the reduced pressure developed above the wing.

Powered aircraft followed in the early 20^{th} century with the Wright brothers and advanced rapidly in World War I with propeller driven war aircraft driven by internal combustion engines and outfitted with fixed wings. The British Sopwith made a part of this application had thick wings constructed with ribs and spars but maintained the underside concave shape of Lilienthal but with a more pronounced convex upper wing shape for greater lift due to reduced pressure on the upper wing surface.

Aircraft design has proceeded for over 100 years until this day using basically the same upper wing convex surface used in the vintage aircraft flown in the first World War which ended in 1917 and a flat or slightly convex undersurface. Aircraft today, cost millions of dollars, carry hundreds of people and cargo and some fly faster than the speed of sound. Yet, few aircraft, outside of certain ultra lights using wings concave underneath can approach the low flying speeds and short landing distances achieved by birds.

While the enormously large and fast fixed wing aircraft of today have created a travel industry unheard of in the 19^{th} century, and specialized military aircraft have achieved a capability of delivering weaponry of unparallel magnitude and weight at world spanning distances, their remains a niche, unfilled by present powered fixed wing aircraft, for a fixed wing aircraft which can land and take off within extremely short distances. Today, high speed jet aircraft are enormously expensive to build, because of their complicated structure, consume enormous amounts of jet fuel, and except for a few advanced drones, are completely inadequate to provide very low altitude tactical support to military forces or civilian police actions.

In like manner, surveillance of terrorist activities, border crossing problems or covert criminal activities go largely unseen by piloted fixed wing aircraft which are either too fast, too big, too expensive, or lack maneuverability capabilities. In short, our present fixed wing aircraft are largely unsuitable for a substantial number of necessary activities. Furthermore, our reconnaissance aircraft are too large, consume too much fuel, and are too expensive to be used in risky low level slow speed surveillance where they might be brought down by any number of weaponry within the means of those under surveillance. A solution to the above problems lies within the purview of the teachings of this invention.

While emulating the shape of birds' wings, the present invention is unbelievably much stronger for it's weight than conventional aircraft construction.

The present invention is an appropriate for all sizes of aircraft. The extreme simplicity makes it very economical to construct. The concave wing shape enables it to land and take off very slowly, making it very useful in backcountry.

### Structural Engineering Background

It is well known to structural design engineers that horizontal simple beams bend downward when loaded, and that the portion of the beam above its neutral axis is stressed in longitudinal compression and that portion of the beam below its neutral axis is stressed in tension. It is also known that because of the downward curvature, the upper portion of the beam which is in compression is being forced downward all along its length and the lower portion being in tension is being forced upward all along its length, causing vertical compression stress on the structure. For this reason vertical members are fastened to steel I-beam webs to protect the webs from buckling.

Fortunately, the vertical compression stress can be reversed by fabricating a structure that is strongly curved in a direction opposite the deflection that occurs when the beam is loaded, and that has so great a curvature that it remains curved when loaded with the maximum design load. It is then stressed in vertical tension instead of compression. (See “Strength of Materials” by F. R. Shanley, 1957 edition, pages 330 and 331, copy enclosed.

Experiments have shown that the material on the compression side of the neutral axis of a structure that has been fabricated with a strong curve opposite in direction to the deflection curve caused by the load and has been curved enough so it will remain curved when loaded with maximum design load, is being forced in a direction opposite the direction of the load caused deflection. The vertical tension created simultaneously causes chord wise tension in the wing material, which holds it from moving in this direction. Therefore, it cannot move in either direction (neither up nor down in a horizontal structure) and so cannot buckle prematurely (before the yield stress of the material has been reached) because the beam longitudinal compression is trying to force it one way and the beam lateral tension is restraining it from moving in that direction.

It is the purpose of this invention to use this phenomenon to protect very thin material such as is typical in aircraft, that is subjected to strong bending forces, from buckling prematurely when in compression. This will greatly simplify fabrication by eliminating most of the stiffening devices now needed in conventional construction. It will also greatly increase strength and reduce weight by making all of the material fully effective, however thin, whether it is stressed in tension or compression.

The proposed type of structure is thin and is curved both laterally and longitudinally. The lateral (chord wise or leading edge of a wing to trailing edge) curvature which is necessary to create lift, provides the structural depth needed for strength. The longitudinal (span wise) hyper curvature causes the vertical tension described above which protects the thin material stressed in compression from premature buckling. The present invention can be used to build aircraft wings and fuselages, as well as hangers, shop buildings, greenhouses of fiberglass-casting resin composite, dwellings, or self-supporting roof elements that can span great distances. since they can be given great structural depth without the risk of premature buckling of thin material which is under compressive stress.

If the above all sounds too good to be possible, it has all been verified repeatedly, using the same formulae, principles of physics, load testing methods, and strength of material data I have used in 35 years of bridge and building design, and that are used in every structure designed in the civilized world.

Being very thin, a hyper camber wing can be shaped like birds' wings. The camber needed to generate aerodynamic lift also provides sufficient structural depth to give the strength needed to resist the bending moments encountered. The camber also causes a concave under surface of the wing which produces increased pressure on the wing under-surface during flight according to Bernoulli's theorem. The increased pressure on the wing under-surface is always present when in flight and can never stall out and so will permit slower landings and takeoffs as in birds' landings and takeoffs.

Conventional aircraft wings are said to get approximately 75 percent of their lift from reduced pressure over the top of the wing. In the proposed invention it is expected that more than half of the lift will come from increased pressure under the wing, generated both by the positive angle of attack and also the Bernoulli theorem effect due to the concave under-surface.

Fuselages are to be composed of two or more full-length hyper camber elements, arranged beside each other around the fuselage, to form the wall which is also the main structure. Each element will be deflected toward the fuselage center approximately half its maximum deflection under maximum design load. Therefore, when any fuselage element is bent by its maximum load, the opposite elements will be relaxed or nearly so, and will not distort, or will not add to the bending stress.

### SUMMARY OF THE INVENTIONS

In accordance with the present invention, novel and useful aircraft wing and fuselage structures are herein provided.

An object of the present invention is to use a thin, light weight, metal or composite material formed in a shape that given the forces acting upon it will cause a substantial portion of the structure in compression to be protected from premature buckling and failure of the thin material.

A further object is to provide a wing and fuselage of an aircraft that is highly maneuverable, virtually stall proof, and can land or take off in very short distances.

A still further object is to provide an aircraft which is light weight, fuel efficient, inexpensive to build, maintain, and operate.

Still another object of the present invention is to store fuel in the fuselage rather than in the wings. Fuel is stored in conventional wings because the thick wings of conventional planes have unused empty space there. Fuel, however, is much more efficiently stored in the fuselage. A light plane wing has around 15 square feet of frontal area which must be pushed through the air, whereas a fuel tank located in the fuselage can be small in frontal cross section and long fore and aft. The wings of the present invention can be much thinner, therefore smaller in frontal cross sectional area than conventional aircraft wings.

The airplane wing of the present invention is shaped like birds' wings in several important ways: It is very thin, except in the forward portion. In the present invention, the thicker forward portion is only to provide a space to locate one or more torque tubes capable of resisting any torsional forces on the wing. It is also reinforced near the leading and trailing edges of the wing as necessary to cause the neutral axis of all wing cross-sections to fall midway between the highest point on the wing cross-section curve and the theoretical wing chord line. This is to provide maximum structural efficiency. The forward thickened portion is formed by dividing the wide, thin structure into two thicknesses (upper and lower) and separating them to form a space just deep enough to fit the required torque tube or tubes, which are securely fastened to the two thicknesses their entire length by any suitable means. The space thus formed can either be left open or filled with a light material such as plastic foam. The forward thickened portion shall have a streamlined shape appropriate for the aerodynamic shape desired. It is only about ⅕^{th} the thickness of present aircraft wings.

Torsion tubes can be many relatively smaller tubes or fewer larger tubes. Two approximately one inch square tubes seem to be adequate for light plane designs. It has been found that, although the torque tubes' primary function is to provide torsional strength and rigidity, the presence of the torsion tubes acting with portions of the main structure to which they are attached will also provide significant resistance to any brief negative bending movements should they occur.

It is unlikely that serious negative bending moments would occur in a non-aerobatic airplane, because the present wing is shaped like a bird's wing, being concave underneath rather than relatively flat or even slightly convex as in conventional powered air craft, which must accommodate spars, unlike the present invention which has no spars. The concave shape of the under surface of the wing of the present invention will create an air pressure increase under the wing due to the “Bernoulli's theorem effect which will be present at all times when the wing is in flight. This constant pressure under the wing creates a constant positive lifting force which will prevent any significant negative bending forces. The wing of the present invention will require less upper aerodynamic camber to produce equivalent mean camber and therefore equal lift because of the great lower positive camber. Consequently, a greater percentage of the lift will come from air pressure increase under the wing, which cannot stall out, rather than from reduced pressure over the wing, which can stall out at slow speeds and high angels of attack. Landings and takeoffs should be much slower, as in the bird landings and takeoffs from tree limbs or land surface. The torsion tubes can be used as channels for control cables or hydraulic tubing for aileron controls. Conventional type ailerons can be made by simply cutting out a piece of the aft part of the wing near the wing tip, and hinging it to the remaining wing. These ailerons would be operated by cables and pulleys or by hydraulic cylinders. Another option would be an aileron or flaperon below and behind the wing trailing edge, as in the Zenith STOL CH 801 plane manufactured by Zenair Company of Midland Ontario, Canada.

Another alternative would be to simply “morph” the wing near its tip, to increase or decrease the mean camber, thereby increasing or decreasing lift near the tip to initiate and control banking.

The present wing must be curved spanwise with spanwise curvature which must be more pronounced where bending moment is greatest, such as near the fuselage, and less pronounced where bending moment is less, as near the wing tips. Both the spanwise or longitudinal curvature and also the chordwise or lateral curvature are convex on top and concave underneath.

The spanwise curvature must be great enough so that when the wing is under maximum stress, significant positive camber (convex above and concave beneath) will still be present at all points. This spanwise curvature must be great enough, and be properly oriented for the present invention to be successful in stabilizing thin, light material against premature buckling.

It is well known to aircraft structural engineers familiar with gull wing type aircraft that the webs of the gull wing spars are in vertical tension when the aircraft is in flight. This is due to the fact that lift force on the wings forces the top flange upward all along its length. Simultaneously, spanwise tension is caused in the lower wing spar flange which, because of the spanwise curvature, pulls down on the web all along its length. Thus, vertical tension in the web results.

Similarly, in the present invention when lift forces the wing upward, the material above the neutral axis is subjected to spanwise compression force. Because of the spanwise curvature, the spanwise compression force forces the material above the neutral axis upward all along its length. Simultaneously the upward force on the wing causes spanwise tension on the material below the neutral axis, pulling the material below the neutral axis down. This results in vertical tension, which resolves into chordwise tension in the wing material. The material above the neutral axis then is being forced upward by the spanwise compression force, and is simultaneously restrained from moving upward by chordwise tension in the material. Thus it is restrained from moving either up or down, and so cannot buckle prematurely (before the yield stress of the material is reached). This is true no matter how thin the material may be. The spanwise curvature must be accurately made so that the degree of curvature is smooth, and continuous.

Design specifications specify that any laterally curved structural member whose radius of lateral curvature is more than 40 times the thickness of its walls shall not be used to resist compressive force, because of the tendency to buckle prematurely. In 1966 and 1974 loading tests were performed on my Hyper Camber beams whose ratios of radius of lateral curvature to material thickness were 158 and 200 respectively, yet they were stressed in compression to near the allowable yield point of 35,000 p.s.i. and did not buckle. Their thicknesses were 0.018″ and 0.015″ (26 and 28 gage) respectively.

Because of the fact that thin material is protected from premature buckling when subjected to strong compressive force, the material in my longitudinally curved and laterally curved hyper camber wing is 100% effective in resisting compression as well as tension forces without the use of any stiffening devices. Wing overall depth, to provide bending strength, is given by the chordwise camber, which is also necessary to produce lift.

Although any light, strong material may be used, aircraft wings are shallow for aerodynamic reasons and therefore are inherently flexible. Consequently, it is recommended that material having a relatively high modulus of elasticity, such as carbon fiber composite, be used for wings so that they will better hold their shape. This is not necessary in the case of fuselage elements for they are typically deeper, therefore they are inherently more rigid, and also stronger for their weight. Fuselages can be made of fiberglass, aluminum alloy, polycarbonate, or any other common light, strong material.

The longitudinally curved and laterally curved hyper camber compound curved structure is herein proposed for fuselages, also. Two three or four of my hyper camber compound curved structures are placed beside each other around the fuselage, and extend the full fuselage length to form the fuselage wall, which is the entire fuselage structure. No stiffening members are required. The only other members required are to provide reinforcement around window or door openings or at engine, landing gear, or wing mountings, or anywhere strong, concentrated forces are imposed. The fuselage longitudinally hyper curved and laterally cambered compound curved structures are each deflected toward the fuselage center an amount approximately one half their deflection under maximum load, and held in this deflected state by being fastened together by riveting or spot-welding their edges together or by other suitable means. As stated earlier, when any hyper camber compound curved fuselage element is loaded to its maximum capacity the diametric opposite fuselage element will be relaxed, or nearly so, and will neither get distorted or add to the fuselage bending load.

It is obvious that when a fuselage is bent in any given direction, only half or less of the longitudinally hyper camber and lateral curved fuselage elements of the present invention will oppose the bending force. But these fuselage elements have great structure depth, and all material in the elements is protected against premature buckling, so it is 100% effective. Experiments have shown that very strong fuselages are possible using very thin light material.

In order to gain maximum structural efficiency, material near the edges of each of the compound curved hyper camber fuselage elements is reinforced by making it thicker, sufficient to cause the neutral axis of the element cross section to fall midway between a hypothetical straight line connecting the two edges and the point on the curve which is farthest from the aforesaid straight line.

In the construction of a fuselage for a commercial air liner, two longitudinally hyper curved and laterally curved compound curved fuselage elements, an upper and lower, can be successfully employed. These would be semi-circular or semi-elliptical in cross section, similar to the beam of 28 gage mild steel load tested in 1974 up to near the yield point of the steel. The fuselage would have two bulkheads, one near the nose and one near the tail. The ends of the aforesaid upper and lower hyper camber fuselage elements would be securely fastened to the aforesaid forward and aft bulkheads and would span the distance between. As described above, they would be deflected toward each other approximately half their maximum deflection under maximum bending load, then fastened to each other while in this deflected state by suitable means. The access door, cockpit and nose, being of conventional construction, would extend forward from the forward bulkhead. The streamlined aft segment, with its empenage, also constructed conventionally would extend aft from the rear bulkhead.

The space between the edges of the aforesaid upper and lower hyper camber fuselage elements caused by the longitudinal curve in each, plus any additional desired space, would be available for windows, except at intervals where means for tying the aforesaid upper hyper camber fuselage element to the lower element would be necessary to hold the upper and lower fuselage elements in their partially deflected state and also to provide torsional strength, if needed. See FIG. 7 and FIG. 8 of the drawings.

Fuselages comprising an upper and a lower longitudinally curved and laterally curved hyper camber element would work very well for fighter aircraft, such as the F-16, because of their great depth of structure and consequent great strength.

In present conventional fuselages, only the part of the skin six times its thickness on either side of a stringer is considered effective in resisting bending moments. This means that fuselage bending moments are resisted mainly by the stringers. In the compound curved hyper camber fuselage there is no skin, as such or stringers. The compound curved hyper camber element serves the function of the skin as well as the function of the stringers. Being protected against premature buckling, it is 100% effective, consequently very light, strong fuselages result, which are also considerably less labor intensive during construction, because of the simplicity.

The wing should go through the lower compound curve hyper camber fuselage element at or near its neutral axis, where it will be securely fastened to the element. At the neutral axis, material is not stressed either in longitudinal tension or longitudinal compression. The fuselage floor will be immediately above the wing, and the compartment below the wing can be the baggage compartment.

For high wing monoplanes, with two seat wide fuselages, the upper and lower compound curve hyper camber fuselage elements can be quite shallow vertically, with enough vertical space left between them to provide side access for both passengers and cargo and provide headroom. The upper and lower elements would be deflected toward each other and held together in the same manner described above. The wing would go over the top of the fuselage and means would be provided to connect it securely to the fuselage.

For twin jet fighter airplanes, three nearly full-length compound curve hyper camber semi-elliptical cross-section fuselage elements would be appropriate as illustrated in FIG. 9. Two compound curve hyper camber elements would be located at the lower left and the lower right regions and the third would be located at top center. The two jet engines would be housed in the back ends of the two lower fuselage elements. The cockpit would be ahead of and above the jet intakes. The wing would go through the fuselage just above the jet engines. The compound curve hyper camber fuselage elements would be pre-deflected toward the fuselage centerline and fastened together as before described.

Referring to FIG. 6, fuselages could consist of four compound curve hyper camber nearly full-length fuselage elements arranged beside each other around the fuselage to form the fuselage wall, becoming simultaneously the main fuselage structure. These four elements would also be deflected toward the fuselage centerline, approximately one half their maximum deflection, as described above.

### BRIEF DESCRIPTION OF THE FIGURES

FIG. 1 is an embodiment of a wing element of the present invention shown in cross section and taken along line 1-1 of FIG. 2.

FIG. 2 is a top plan view of the wing shown in FIG. 1.

FIG. 3 illustrates a compound curve hyper camber wing cross section of the present invention.

FIG. 4 is a cross section of another form of wing of the present invention taken along line 4-4 of FIG. 5.

FIG. 5 is a top plan view of the wing of the present invention shown in FIG. 4.

FIG. 6 is a cross section of another form of wing of the present invention attached to a fuselage, also shown in section.

FIG. 7 is a partial cross section of the wing and fuselage shown in FIG. 6.

FIG. 8 is a partial cross section of still another form of wing and fuselage of the present invention showing seating placement in a proposed large commercial passenger airliner.

FIG. 9 is a partial cross section of still another alternate form of the present invention showing the use of three compound curve hyper camber elements in the construction of the fuselage.

### DESCRIPTION OF THE INVENTION

The present invention consists of a structure configured to resist bending stresses resulting from design loads; the structure being further configured so that the bending stresses produce force components which resist buckling of thin material portions of the structure stressed in compression.

The structure is of relatively thin sheet material and curved laterally throughout a substantial portion of its length, to an overall selected depth sufficient to provide the necessary strength to resist maximum design bending stress. The structure also has a longitudinally cambered shape that is initially curved opposite to the bend that occurs when the structure is loaded, and has an initial cambered magnitude sufficient so that positive residual camber remains under maximum design load, the longitudinally cambered configuration curvature and orientation, is selected so that, when loaded, a longitudinal compressive force exists, having force components directed away from the center of longitudinal curvature. The longitudinal compressive force and the force components result from the material on the longitudinally convex side of the neutral axis of the structure being in compression and the material on the concave side of the neutral axis being in tension when the structure is loaded, the loading being always oriented in a direction tending to straighten the longitudinal curvature, these two opposing force components will then prevent any material, however thin, from moving either up or down in a horizontal structure, or in either direction normal to the material surfaces when the structure is otherwise oriented.

Specifically, the present invention is for an aircraft hyper camber wing 21 or fuselage constructed, as previously set forth, that can be made very thin, and be protected against premature buckling, when stressed less than the material yield stress. Specifically, the hyper camber wing 21 is shaped from thin material and configured like a bird's wing, for better aerodynamic efficiency, providing a finished wing which has an aerodynamic camber great enough to provide the overall depth needed for design strength. The wing 21 has a concave under-surface 27, capable of generating lift by increasing air pressure under the wing 21 according to Bernoulli's theorem, which cannot stall out at slow speeds and high attack angles, as does the reduced air pressure over current airplane wings. Consequently, the stall speed of the hyper camber wing 21 is greatly reduced. To obtain maximum structural efficiency, the wing 21 is thickened near its leading 4 and trailing 36 edges sufficient to cause the neutral axis 37 of the wing cross-section to be generally midway between the point of maximum camber 30 and the chord line 17.

More specifically, the wing structure 7 as set above is a solid, single thickness wing structure which is separated into an upper part 32 and a lower part 33 in the forward part of the wing structure 7 only, and one or more torsion tubes 3 of light strong material are placed between the upper and lower parts and securely fastened to both the upper and lower parts the full length of the wing, having sufficient torsional strength to provide the required wing torsional rigidity.

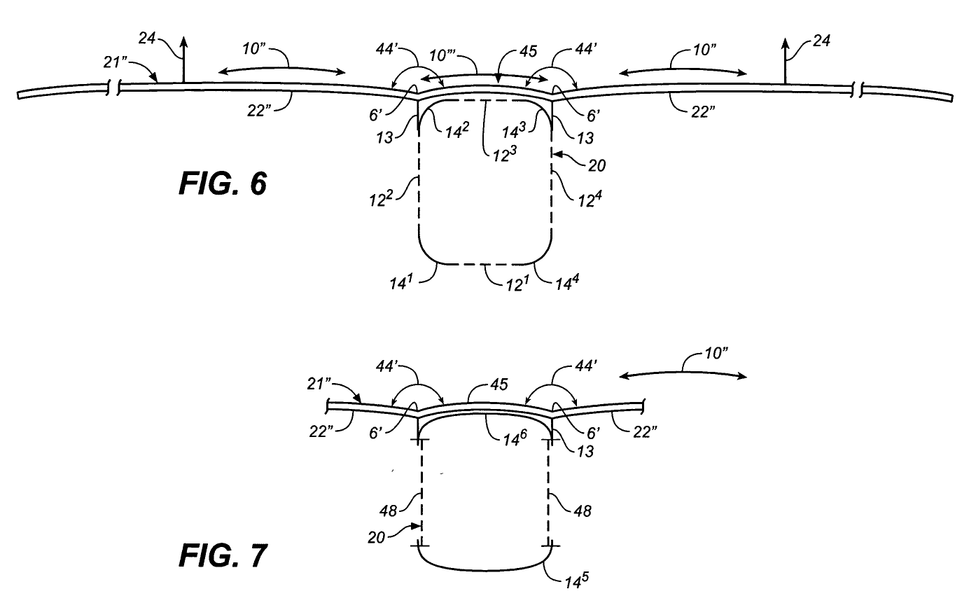

Remarkably an aircraft fuselage structure 20′ composed of two or more nearly full length components 14¹, 14² is constructed according to the same structural design as set forth above for the wings. As shown in FIGS. 6-9, the two nearly full length components are installed side by side, or one above the other to comprise part or all of the fuselage wall which is also the complete fuselage structure. All components are deflected toward the fuselage centerline one-half the amount of their maximum deflection and fastened to each other. The deflection toward the fuselage centerline will produce protection against premature buckling as previously described for constructing the wings. According to well known principles, a curved structural member that is subjected to end to end compressive force will tend to become more curved and, conversely, if subjected to end to end tension force it will tend to straighten out. These effects against premature buckling are due to the facts that longitudinal compression force produces force components along the member that are directed away from the center of longitudinal curvature and that longitudinal tension force produces force components along the member directed toward the center of longitudinal curvature. This invention provides hyper longitudinal camber sufficient in magnitude to cause residual curvature in a direction opposite the direction of the curvature caused by the design load, even when the member is fully loaded.

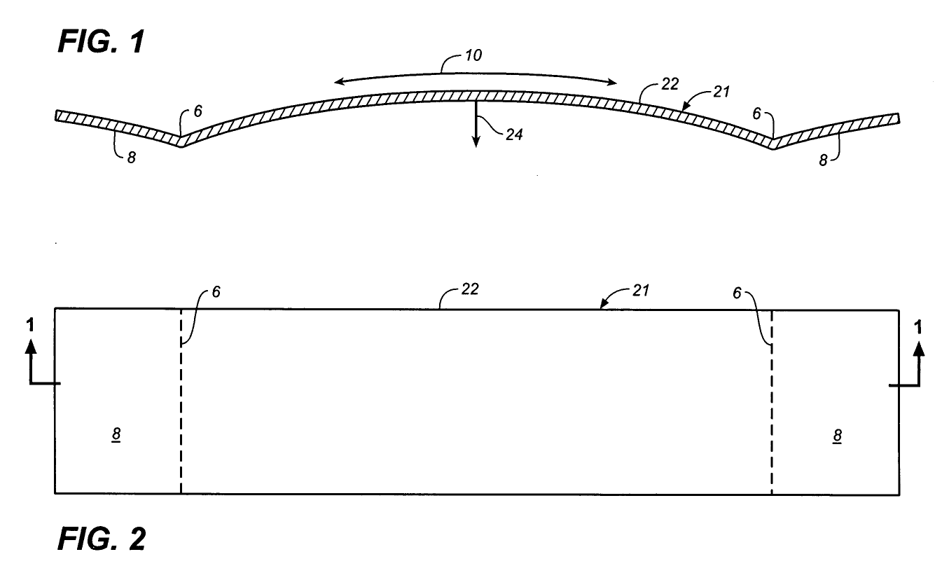

One embodiment of the present invention is shown in FIGS. 1 and 2. FIG. 1 is a cross section of an airplane wing 21 of the present invention taken along line 1-1 of FIG. 2. FIG. 2 is a top plan view of the airplane wing 21 shown in FIG. 1. The line shown on FIG. 2 and indicated by the number 6, depicts the location where the upwardly curved main wing 22 and wing tip portion 8 intersect and form dihedral angle 44. The spanwise curvature 10, 10′, 10″, 10′″, and 10″″ respectively shown in FIGS. 1, 4, 6, 7, 8, and 9 is present in all forms of wings that use the present invention. This longitudinal spanwise curvature must be so formed that when the wing 21 is loaded to its maximum capacity there will still be positive camber (curvature opposite the deflection that takes place when the wing is loaded), of sufficient magnitude that the force components resulting from the part of the curved wing under longitudinal compression will resist any and all distributed loading forces, and have a residual force component represented by arrow 24 in a direction opposite the load force direction.

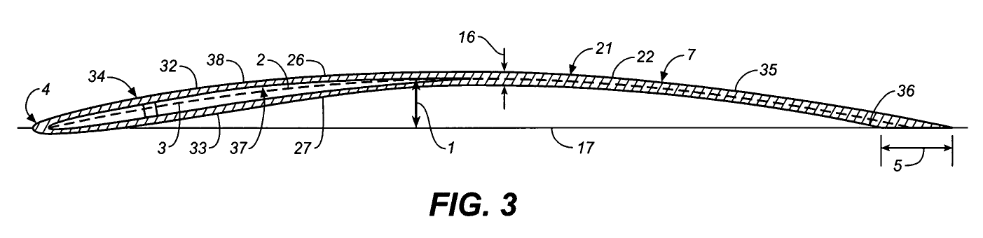

FIG. 3 illustrates a typical wing 21 cross section. The mean camber line 2, shown as a dashed line, is the locus of all points midway between the upper 26 and lower 27 surfaces. The mean camber line consists of two parabolic curves; a forward curve and a rearward curve joined at their apexes somewhere between 20% and 60% of the chord line behind the wing leading edge 4 depending upon the aerodynamic shape desired The main wing structure 7 is separated into an upper portion 32 and a lower portion 33 in the forward part 34 of the main wing structure 7 to provide space for one or more nearly full length torque tubes 3 which are firmly fastened to the upper and lower portions 32 and 33 of the main structure 7; their full length to provide wing torsional strength. The aft portion 35 of the main structure 7 shall be one solid structure. Its thickness 16 shall be varied being greater wherever bending moment is great, such as near the fuselage, and thinner where bending moment is less; at or near the wingtips for example. The main wing structure 7 shall be made thicker near its leading edge 4 and near its trailing edge 36 sufficient to cause the neutral axis 37 of all wing cross sections to fall midway between the point of maximum camber 38, as for example point 38 in and the theoretical chord line 17. In lieu of thickening the trailing edge 36, a segment 5 may be added to the trailing edge 36 in line with the chord line 17 of sufficient size to produce the same result.

The leading edge 4 of wing 21 shown in FIG. 3 may be either rounded for subsonic flight or sharp edged for super sonic flight.

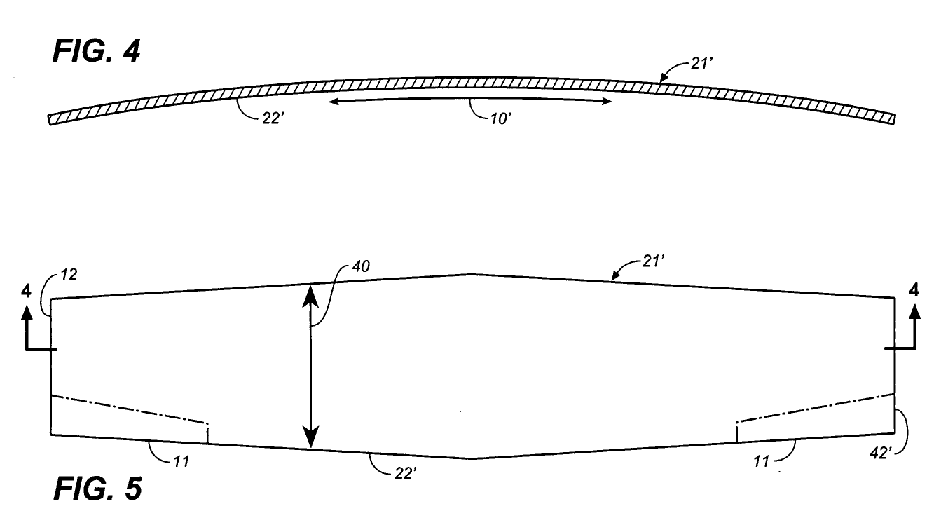

FIG. 4 is a cross section of a typical wing 21′ taken along line 4-4 in FIG. 5. FIG. 5 shows a plan view of the same wing 21′. Ailerons 11 are hinged to wing 21′ and operate conventionally. The chord length 40 of wing 21′ shortens from midwing point 41 to wing tip 42 and 42′ respectively as shown in FIG. 5.

FIG. 6 shows a cross sectional view of an airplane fuselage which is composed of four nearly full length elements, designated generally by the number 14 and specifically by the numbers 14¹, 14², 14³, and 14⁴ that have been deflected toward the fuselage center an amount approximately half the deflection expected when loaded to their full capacity. While elements 14¹, 14², 14³, and 14⁴ are held in this deflected position, elements, designated generally by the number 12 and specifically by the numbers 12¹, 12², 12³, and 12⁴ are fastened to deflected elements 14¹, 14², 14³, and 14⁴ so as to hold elements 14¹, 14², 14³, and 14⁴ in their half deflected position. Thus when any element 14¹, 14², 14³, or 14⁴ is loaded to its maximum capacity, the diametrically opposite element, will be fully relaxed, or nearly so, and their shape will not be distorted, or they will not add to or detract from the stress on other elements.

It is also possible to build fuselages wherein the elements 12¹, 12², 12³, and 12⁴ are eliminated and the full width elements 14¹, 14², 14³, and 14⁴ are fastened to each other at their edges, or any combination of the above. Elements 12¹, 12², 12³, and 12⁴ may be replaced with tension members spaced at appropriate intervals with windows or doors in between. Fuselages may also be made of transparent materials, such as polycarbonate or fiberglass-casting resin composite.

Like the wings, the elements 14¹, 14², 14³, and 14⁴ shall be curved longitudinally (from fore to aft); being curved in a direction away from the fuselage centerline. Elements 14¹, 14², 14³, and 14⁴ shall also be curved laterally, as shown, to provide the desired aerodynamic shape and simultaneously to provide structural depth for strength.

FIG. 6 and FIG. 7 show a method of attaching the portion 45 of wing 21 to the fuselage 20 with attachment members 13. Attachment members 13 are also designed to reinforce the fuselage 20 at the wing 21″ dihedral angle locations 6′, forcing the wing 21″ to hold its shape and not flatten out when loaded because of the dihedral angle 44′.

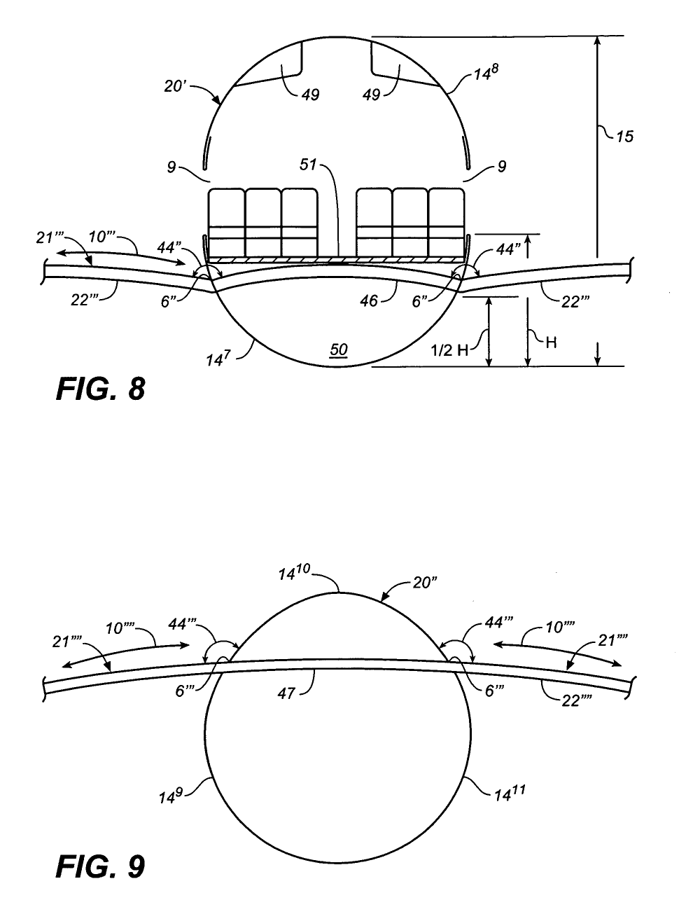

FIG. 7 and FIG. 8 show cross sections of fuselages 20 and 20′ whose main structure comprises two nearly full-length hyper camber structural elements, curved longitudinally and laterally in a compound curve and designated respectively generally by the numbers 14⁵ and 14⁶ and 14⁷ and 14⁸. In FIG. 7, the two structural elements 14⁵ and 14⁶ are tied to each other by means of the side members 48, being held in their half-deflected state as previously described. Fuselage 20 as shown in FIG. 7 would be useful for light, high wing monoplanes.

FIG. 8 shows the cross-section of a fuselage appropriate for large aircraft such as commercial passenger planes. The Hyper Camber top structure 14⁸ and bottom structure 14⁷ are both very deep structurally providing great strength. The upper spaces 49, are available for luggage and the lower space 50 can be used for luggage, cargo or fuel. The vertical dimensions 15 will vary from front to rear because of the longitudinal curvatures of the upper hyper camber structure 14⁸ and the lower hyper camber structure 14⁷.

Referring to FIG. 8, spaces 9 in the fuselage 20′ sides will, of course, vary in height also. Spaces 9 would be filled with windows alternated with structure to hold the upper and lower hyper cambered structures 14⁷, 14⁸ in their half-deflected state. The wing 22′″ should go through the lower hyper cambered structure 14⁷ where its neutral axis is located to reduce any negative influence on its ability to resist bending moment. The floor 51 of the fuselage 20′ would be located just above curved wing portion 46 of the wing 22′″, and appropriate conversional reinforcement will be provided at the wing attachment to the fuselage.

FIG. 9 shows the cross section for a fuselage 20″, the main structure of which is composed of three hyper camber fuselage structural elements 14⁹, 14¹⁰ and 14¹¹ extending nearly the full fuselage length and being held in a half deflected state, as described above. The three element orientation shown in FIG. 9 would be appropriate for twin motor fighter jets, wherein the two jet motors would be mounted in the aft portions of the two lower hyper camber structural elements 14⁹ and 14¹¹. The wing 20″″ would go through the fuselage 20″ between the upper hyper camber element 14¹⁰ and the two lower hyper camber elements 14⁹ and 14¹¹, being, of course, securely fastened to the hyper camber structural elements 14⁹, 14¹⁰ and 14¹¹.

All fuselages comprising the hyper camber structural elements will have two bulkheads; one near the bow and one near the tail; and the ends of the hyper camber fuselage structural elements will be securely fastened to the bulkheads. The bulkheads will be designed to withstand the strong radial compression force imposed due to the deflection of the hyper camber fuselage structural elements being forced toward the fuselage center and held there.

The nose, cockpit and access door will be ahead of the front bulkhead and be of conventional construction. The empenage will be behind the rear bulkhead and be also of conventional construction.

I claim:

1. A structure configured to resist bending stresses resulting from design loads, said structure being further configured so that said bending stresses produce force components which resist buckling of thin material portions of said structure stressed in compression, comprising:
a. said structure being of relatively thin sheet material and curved laterally throughout a substantial portion of its length, to an overall selected depth to provide the necessary strength to resist maximum design bending stress;
b. said structure having a longitudinally cambered shape that is initially curved opposite to the bend that occurs when the structure is loaded, and having an initial cambered magnitude so that positive residual camber remains under maximum design load, said longitudinally cambered configuration curvature and orientation, being selected so that when loaded, causes a longitudinal compressive force having force components directed away from the center of longitudinal curvature and resulting in a longitudinal tension force having components toward the center of said longitudinal curvature, said longitudinal compressive force and said force components result from the material on the longitudinally convex side of the neutral axis of the structure being in compression and the material on the concave side of the neutral axis of said structure being in tension when the structure is loaded, said loading being always oriented in a direction tending to straighten the longitudinal curvature, these two opposing force components will then prevent any material, however thin, from moving either up or down in a horizontal structure, or in either direction normal to the material surfaces when the structure is otherwise oriented.

2. An aircraft hyper camber wing constructed as in claim 1 that can be made very thin, and be protected against premature buckling, when stressed less than the material yield stress comprising:
a. said wing being shaped thin and configured like a bird's wing, for better aerodynamic efficiency, providing a finished wing which has an aerodynamic camber great enough to provide the overall depth needed for design strength, having a concave under-surface, capable of generating lift by increasing air pressure under the wing according to Bernoulli's theorem, which cannot stall out at slow speeds and high attack angles, as does the reduced air pressure over current wings, consequently, the stall speed of said hyper camber wing is greatly reduced; to obtain maximum structural efficiency, said wing is thickened near its leading and trailing edges sufficient to cause the neutral axis of the wing cross-section to be generally midway between the point of maximum camber and the chord line.

3. A wing structure as set forth in claim 1 in which the solid, single thickness wing structure is separated into an upper part and a lower part in the forward part of the wing only, and one or more torsion tubes of light strong material are placed between said upper and lower parts and securely fastened to both the said upper and lower parts a substantial portion of the full length of said wing, having sufficient torsional strength to provide the required wing torsional rigidity.

4. An aircraft fuselage structure composed of two or more nearly full length components, constructed according to said structure of claim 1, that are installed side by side, around the periphery of the fuselage, to comprise the fuselage wall which is also the complete fuselage structure and are deflected toward the fuselage centerline one-half the amount of their maximum deflection and firmly fastened to each other, said deflection toward the fuselage centerline will produce protection against premature buckling as described in claim 1 according to well known principles that a curved structural member that is subjected to end to end compressive force will tend to become more curved and, conversely, if subjected to end to end tension force it will tend to straighten out. These effects against premature buckling are due to the facts that longitudinal compression force produces force components along said member that are directed away from the center of longitudinal curvature and that longitudinal tension force produces opposing force components along the member directed toward the center of longitudinal curvature; the thin material then cannot move either way normal to its surfaces. This invention provides hyper longitudinal camber sufficient in magnitude to cause residual curvature in a direction opposite the direction of the curvature caused by the design load, even when the member is fully loaded.
